(19) United States
(12) Patent Application Publication
(10) Pub. No.: US 2025/0296307 A1
(43) Pub. Date: Sep. 25, 2025

(54) PACKAGING MATERIAL WITH GAS BARRIER FILM

(71) Applicant: FUJIFILM Corporation, Tokyo (JP)

(72) Inventors: Tomokazu SEKI, Minamiashigara-shi (JP); Eijiro IWASE, Minamiashigara-shi (JP)

(73) Assignee: FUJIFILM Corporation, Tokyo (JP)

(21) Appl. No.: 19/230,481

(22) Filed: Jun. 6, 2025

Related U.S. Application Data
(63) Continuation of application No. PCT/JP2023/039362, filed on Nov. 1, 2023.

(30) Foreign Application Priority Data
Dec. 9, 2022 (JP) 2022-196973

(51) Int. Cl. B32B 27/08; B32B 7/023; B32B 15/085; B32B 15/095; B32B 15/20; B32B 27/32; B32B 27/36; B32B 27/40

(52) U.S. Cl. CPC B32B 27/08; B32B 7/023; B32B 15/085; B32B 15/095; B32B 15/20; B32B 27/32; B32B 27/36; B32B 27/40; B32B 2255/10; B32B 2255/20; B32B 2255/26; B32B 2255/28; B32B 2307/414; B32B 2307/7246; B32B 2439/46

(57) ABSTRACT

Provided is a packaging material with a gas barrier film having high visibility. The packaging material with a gas barrier film includes: a packaging material that includes a resin film; a first barrier film that is bonded to a surface of the packaging material opposite to one surface; and a second barrier film that is bonded to the one surface of the packaging material and includes an aluminum layer, in which the first barrier film includes an underlying organic layer, an inorganic layer, and a protective organic layer in this order on a support, peripheral portions of the packaging material and the first barrier film are bonded to form a space between the packaging material and the first barrier film, and a haze layer having a haze of 10% to 50% is provided between the packaging material and the first barrier film.

### CROSS-REFERENCE TO RELATED APPLICATIONS

This application is a Continuation of PCT International Application No. PCT/JP2023/039362 filed on Nov. 1, 2023, which claims priority under 35 U.S.C. § 119(a) to Japanese Patent Application No. 2022-196973 filed on Dec. 9, 2022. The above applications are hereby expressly incorporated by reference, in their entirety, into the present application.

### BACKGROUND OF THE INVENTION

### 1. Field of the Invention

The present invention relates to a packaging material with a gas barrier film.

### 2. Description of the Related Art

As a packaging material that packages chemical liquid, powdered drug, food, powder (for example, sugar) that is weak to moisture, or the like, a resin film formed in a bag shape is used. For example, an infusion bag filled with an infusion solution including sugar, electrolyte liquid, amino acid, vitamin, and the like is known.

The resin film used as a material of a bag body in direct contact with chemical liquid in the packaging material forming the infusion bag has low gas barrier properties. The reason for this is to prevent additives for improving the gas barrier properties of the resin film from eluting into the infusion solution.

However, the chemical liquid such as sugar, amino acid, and electrolyte liquid filled in the infusion bag is likely to be significantly denatured by water and/or oxygen. Therefore, in a case where the bag body leaves to stand in the atmosphere, water and/or oxygen in the atmosphere may transmit through the infusion bag to denature the quality of the chemical liquid.

Accordingly, by bonding two gas barrier films having gas barrier properties to both surfaces of the bag body formed of the resin film or the like, respectively, to form an infusion bag, the gas barrier properties are ensured.

In addition, in the infusion bag, in order to check mixing of foreign matter in the drug or the like, discoloration of the drug, and the like, as at least one of the gas barrier films, a transparent barrier film having high gas barrier properties and high transparency and including an organic layer and an inorganic layer is used.

For example, JP2014-184627A describes that a laminated film where a sealant film is laminated on a barrier film is heated to bond the laminated film to a resin film (bag body), the barrier film including a barrier laminate that includes a substrate film, at least one organic layer, and at least one inorganic layer.

From the viewpoint of checking the inside of the packaging material, the transparent barrier film having transparency and including the organic layer and the inorganic layer only has to be bonded to one surface. Therefore, a configuration where a metal barrier film having higher gas barrier properties and including a metal layer (aluminum layer) where breakage or the like is not likely to occur is bonded to the other surface is known.

In addition, the gas barrier film and the resin film are thermally fused through a thermal fusion layer. In a case where the transparent barrier film is thermally fused to the resin film (bag body) through the thermal fusion layer, during the thermal fusion of the entire surface, the inorganic layer is fractured, and there is a concern that barrier properties may decrease. In addition, in a case where a region to be thermally fused is large, wrinkles are generated due to the effect of stress generated during contraction by heat, and there is a risk that air bubbles are formed in an adhesive layer. Therefore, as described in JP2014-184627A, the thermal fusion of the transparent barrier film and the bag body is performed only in peripheral portions. Accordingly, a space is formed between the bag body and the thermal fusion layer.

### SUMMARY OF THE INVENTION

Here, according to an investigation by the present inventors, as described above, in the configuration where the metal barrier film is bonded to one surface of the bag body and the transparent barrier film is bonded to the other surface of the bag body, the inside of the packaging material is checked using reflected light of light incident from the transparent barrier film side into the bag body. In this case, in the configuration including the space between the bag body and the thermal fusion layer, light is reflected from an interface between the space and the bag body (resin film). Therefore, it was found that reflected glare of a light source or the like occurs such that the visibility of the inside of the packaging material deteriorates.

An object of the present invention is to solve the above-described problem of the related art and to provide a packaging material with a gas barrier film having high visibility.

In order to achieve the object, the present invention has the following configurations.

[1] A packaging material with a gas barrier film, comprising:
a packaging material that includes a resin film;
a first barrier film that is bonded to one surface of the packaging material; and
a second barrier film that is bonded to a surface of the packaging material opposite to the one surface and includes an aluminum layer,
in which the first barrier film includes an underlying organic layer, an inorganic layer, and a protective organic layer in this order on a support,
peripheral portions of the packaging material and the first barrier film are bonded to form a space between the packaging material and the first barrier film, and
a haze layer having a haze of 10% to 50% is provided between the packaging material and the first barrier film.

[2] The packaging material with a gas barrier film according to [1],
in which a thermal fusion layer that bonds the packaging material and the first barrier film to each other is provided, and
the thermal fusion layer is the haze layer.

[3] The packaging material with a gas barrier film according to [2],
in which a surface of the first barrier film on the protective organic layer side and the thermal fusion layer adhere to each other through an adhesive layer.

[4] The packaging material with a gas barrier film according to any one of [1] to [3],
in which a water vapor transmission rate of the first barrier film under conditions of a temperature of 25° C. and a relative humidity of 50% RH is 1.0×10⁻⁴ g/(m²·day) or less.

[5] The packaging material with a gas barrier film according to any one of [1] to [4],
in which a haze value of the first barrier film is less than a haze value of the haze layer.

[6] The packaging material with a gas barrier film according to any one of [1] to [5], in which a total light transmittance of the first barrier film at a wavelength of 380 nm to 780 nm is 85% or more.

According to the present invention, it is possible to provide a packaging material with a gas barrier film having high visibility.

### BRIEF DESCRIPTION OF THE DRAWINGS

FIG. 1 is a diagram conceptually showing an example of a packaging material with a gas barrier film according to the present invention.

FIG. 2 is a diagram conceptually showing an example of a laminate including a first barrier film that is bonded to one surface of the packaging material with a gas barrier film of FIG. 1.

FIG. 3 is a diagram conceptually showing an example of a laminate including a second barrier film that is bonded to the other surface of the packaging material with a gas barrier film of FIG. 1.

### DESCRIPTION OF THE PREFERRED EMBODIMENTS

Hereinafter, a packaging material with a gas barrier film according to an embodiment of the present invention will be described in detail based on preferred examples shown in the accompanying drawings.

In the present invention, numerical ranges represented by “to” include numerical values before and after “to” as lower limit values and upper limit values.

[Packaging Material with Gas Barrier Film]

A packaging material with a gas barrier film according to the embodiment of the present invention comprises:
a packaging material that includes a resin film;
a first barrier film that is bonded to a surface of the packaging material opposite to one surface; and
a second barrier film that is bonded to the one surface of the packaging material and includes an aluminum layer,
in which the first barrier film includes an underlying organic layer, an inorganic layer, and a protective organic layer in this order on a support,
peripheral portions of the packaging material and the first barrier film are bonded to form a space between the packaging material and the first barrier film, and
a haze layer having a haze of 10% to 50% is provided between the packaging material and the first barrier film.

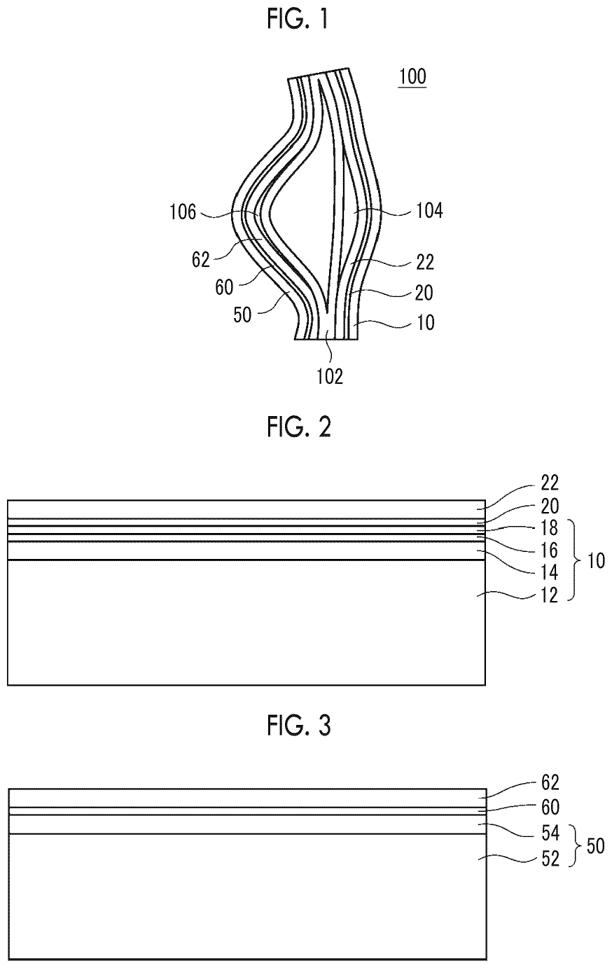

FIG. 1 is a diagram conceptually showing an example of the packaging material with a gas barrier film according to the embodiment of the present invention.

A packaging material 100 with a gas barrier film shown in FIG. 1 includes: a packaging material 102; a thermal fusion layer 22, an adhesive layer 20, and a first barrier film 10 that are laminated on one surface of the packaging material 102; and a thermal fusion layer 62, an adhesive layer 60, and a second barrier film 50 that are laminated on the other surface of the packaging material 102.

As shown in FIG. 1, in the packaging material 100 with a gas barrier film, peripheral portions of the packaging material 102 and the first barrier film 10 are bonded to form a space 104 between the packaging material 102 and the first barrier film 10. Likewise, peripheral portions of the packaging material 102 and the second barrier film 50 are bonded to form a space 106 between the packaging material 102 and the second barrier film 50.

### [Packaging Material]

The kind of the packaging material (bag body) 102 is not particularly limited, and is preferably used for packaging a product that requires gas barrier properties. Examples of the product to be packaged include food, non-food, and chemical. The state of the product to be packaged may be liquid, solid, or powdered. It is preferable that, by appropriately performing heat sealing, the packaging material is bag-shaped. Specific examples of the packaging material include a packaging bag for food, a packaging bag for chemical, and an infusion bag.

Specifically, examples of the packaging material 102 include a resin bag obtained by forming a resin film such as a polyethylene resin or a polypropylene resin in a bag shape. Examples of the packaging material 102 include a bag obtained by joining two resin films and a bag obtained by folding and joining one resin film. In the packaging material 102, typically, end parts of the resin film other than a necessary outlet (for example, a liquid discharge port of an infusion bag) may be completely joined.

The thickness of the resin film of the resin bag is preferably 20 to 200 μm.

In the case of the bag obtained by joining two resin films, the two resin films may be films consisting of different materials but are preferably films consisting of the same material. In a case where the films consisting of the same material are bonded to each other using a heat sealing method, the films can be easily bonded to each other.

### (Infusion Bag)

In a case where the packaging material 102 is an infusion bag, the infusion bag may be a single type including one accommodation chamber where the content is packaged or may be a duplex type including two or more accommodation chambers. Examples of the duplex type include a duplex bag consisting of a powder accommodation chamber and a liquid accommodation chamber that is separated from the liquid accommodation chamber through an easily peelable partition wall. In this case, immediately after use, the partition wall is peeled off to mix powder and liquid, and the mixture is infused from the liquid discharge port. In this case, it is preferable that the packaging material with a gas barrier film according to the embodiment of the present invention is used for the powder accommodation chamber.

Examples of the drug used in the infusion bag include liquid to be administered under the skin or into the blood vessel or abdominal cavity by drip infusion or the like. In the case of the duplex bag, examples of the drug include powdered drug and liquid such as saline. Examples of the powder drug include a nutrient such as vitamin or amino acid, an antibiotic, and an antibacterial agent.

In addition, within a range not departing from the scope of the present invention, techniques described in JP2003-230618A and JP1998-201818A (JPH10-201818A) can be considered.

### [First Barrier Film]

FIG. 2 conceptually shows an example of a laminate including a first barrier film (hereinafter, also referred to as “gas barrier film”). FIG. 2 is a conceptual diagram where the gas barrier film is seen from a plane direction of a main surface (direction parallel to the main surface). The main surface is the maximum surface of a sheet-shaped material (a film or a plate-shaped material).

A gas barrier film 10 shown in FIG. 2 includes a support 12, an underlying organic layer 14, an inorganic layer 16, and a protective organic layer 18 in this order. In addition, the thermal fusion layer 22 is bonded to the protective organic layer 18 side of the gas barrier film 10 through the adhesive layer 20.

In the following description, the support 12 side of the gas barrier film 10 will also be referred to as “lower side”, and the thermal fusion layer 22 side thereof will also be referred to as “upper side”. This point also applies to the second barrier film described below and shown in FIG. 3.

The gas barrier film 10 used in the packaging material with a gas barrier film according to the embodiment of the present invention includes the inorganic layer 16 that mainly exhibits gas barrier performance, the underlying organic layer 14 that functions as an underlying layer of the inorganic layer 16, and the protective organic layer 18 that functions as a protective layer for protecting the inorganic layer 16.

In the example shown in FIG. 2, the gas barrier film 10 includes one combination of the underlying organic layer 14 and the inorganic layer 16 but is not limited thereto. The gas barrier film 10 may include two or more combinations of the underlying organic layers 14 and the inorganic layers 16. That is, for example, the gas barrier film may have a configuration where the support 12, the underlying organic layer 14, the inorganic layer 16, the underlying organic layer 14, the inorganic layer 16, and the protective organic layer 18 are laminated in this order.

### <Support>

As the support 12, a well-known sheet-shaped material (a film or a plate-shaped material) that is used as a support for various gas barrier films, various laminated functional films, and the like can be used.

A material of the support 12 is not particularly limited, and various materials can be used as long as the underlying organic layer 14 and the inorganic layer 16 can be formed. As the material of the support 12, a material having high transparency is preferable and, for example, various resin materials can be used.

Examples of the material of the support 12 include polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), an acrylonitrile-butadiene-styrene copolymer (ABS), a cycloolefin copolymer (COC), a cycloolefin polymer (COP), triacetyl cellulose (TAC), and an ethylene-vinyl alcohol copolymer (EVOH).

The thickness of the support 12 can be appropriately set depending on the use, the material, and the like.

The thickness of the support 12 is not limited, but is preferably 5 to 150 μm and more preferably 10 to 100 μm from the viewpoints that, for example, the mechanical strength of the gas barrier film 10 can be sufficiently ensured, a gas barrier film having good flexibility can be obtained, and the weight and thickness of the gas barrier film 10 can be reduced.

### <Underlying Organic Layer>

In the gas barrier film 10, the underlying organic layer 14 is formed on one surface of the support 12.

The underlying organic layer 14 consists of, for example, an organic compound obtained by polymerization (crosslinking or curing) of a monomer, a dimer, an oligomer, or the like.

The underlying organic layer 14 functioning as the underlayer of the inorganic layer 16 is an underlayer for appropriately forming the inorganic layer 16.

The underlying organic layer 14 formed on the surface of the support 12 embeds unevenness of the surface of the support 12, foreign matter attached to the surface, and the like to appropriately planarize the formation surface of the inorganic layer 16 such that the inorganic layer 16 can be appropriately formed.

In the present invention, the gas barrier film may include plural sets of combinations of the inorganic layers 16 and the underlying organic layers 14. In this case, the second or subsequent underlying organic layer 14 is formed on the inorganic layer 16. Even in this configuration, the underlying organic layer 14 functioning as the underlayer (the formation surface of the inorganic layer 16) of the inorganic layer 16 exhibits the same action.

In particular, by providing the underlying organic layer 14 on the surface of the support 12, the inorganic layer 16 that mainly exhibits gas barrier properties can be appropriately formed.

The underlying organic layer 14 is formed, for example, by curing a composition for forming an organic layer, that includes an organic compound (a monomer, a dimer, a trimer, an oligomer, a polymer, and the like). The composition for forming an organic layer may include one kind or two or more kinds of organic compounds.

The underlying organic layer 14 includes, for example, a thermoplastic resin and an organic silicon compound. Examples of the thermoplastic resin include polyester, a (meth)acrylic resin, a methacrylic acid-maleic acid copolymer, polystyrene, a transparent fluororesin, polyimide, fluorinated polyimide, polyamide, polyamide imide, polyether imide, cellulose acylate, polyurethane, polyether ether ketone, polycarbonate, an alicyclic polyolefin, polyarylate, polyethersulfone, fluorene ring-modified polycarbonate, alicyclic-modified polycarbonate, fluorene ring-modified polyester, and an acrylic compound. Examples of the organic silicon compound include polysiloxane.

From the viewpoints of high strength and glass transition temperature, it is preferable that the underlying organic layer 14 includes a polymer of a radically curable compound and/or a cationically curable compound having an ether group.

From the viewpoint of reducing the refractive index of the underlying organic layer 14, it is preferable that the underlying organic layer 14 includes a (meth)acrylic resin including, as a major component, a polymer of a monomer, an oligomer, or the like of (meth)acrylate. By reducing the refractive index of the underlying organic layer 14, transparency increases, and a light-transmitting property is improved.

It is more preferable that the underlying organic layer 14 includes a (meth)acrylic resin including, as a major component, a monomer, a dimer, an oligomer, or the like of a bi- or higher functional (meth)acrylate such as dipropylene glycol di(meth)acrylate (DPGDA), trimethylolpropane tri(meth)acrylate (TMPTA), or dipentaerythritol hexa(meth)acrylate (DPHA), and it is still more preferable that the underlying organic layer 14 includes a (meth)acrylic resin including, as a major component, a polymer of a monomer or a polymer such as a dimer, an oligomer of a tri- or higher functional (meth)acrylate. In addition, a plurality of (meth)acrylic resins may be used. The major component refers to a component having the highest content mass ratio among components included.

It is preferable that the composition for forming an organic layer includes an organic solvent, a surfactant, and a silane coupling agent in addition to the organic compound.

In a case where a plurality of underlying organic layers 14 are provided, that is, in a case where plural sets of combinations of the underlying organic layers 14 and the inorganic layers 16 are provided, the materials of the underlying organic layers 14 may be the same as or different from each other.

The thickness of the underlying organic layer 14 is not limited and can be appropriately set according to components in the composition for forming an organic layer, the support 12 used, and the like.

The thickness of the underlying organic layer 14 is preferably 0.1 to 5 μm and more preferably 0.2 to 3 μm. It is preferable that the thickness of the underlying organic layer 14 is 0.1 μm or more from the viewpoint of embedding unevenness of the surface of the support 12, foreign matter attached to the surface, and the like such that the surface of the underlying organic layer 14 can be planarized. It is preferable that the thickness of the underlying organic layer 14 is 5 μm or less from the viewpoints that, for example, cracks of the underlying organic layer 14 can be prevented, the flexibility of the gas barrier film 10 can be improved, and the thickness and weight of the gas barrier film 10 can be reduced.

In a case where a plurality of underlying organic layers 14 are provided, that is, a case where plural sets of combinations of the inorganic layers 16 and the underlying organic layers 14 are provided, the thicknesses of the respective underlying organic layers 14 may be the same as or different from each other.

The underlying organic layer 14 can be formed with a well-known method depending on materials.

For example, the underlying organic layer 14 can be formed with a coating method of applying the above-described composition for forming an organic layer and drying the composition for forming an organic layer. During the formation of the underlying organic layer 14 with the coating method, the dried composition for forming an organic layer is irradiated with ultraviolet rays to polymerize (crosslink) the organic compound in the composition for forming an organic layer.

The underlying organic layer 14 may be formed through so-called roll-to-roll (RtoR) of applying and drying the composition for forming an organic layer while transporting a support, or may be formed using a so-called sheet-feeding method using a support in the form of a cut sheet.

### <Inorganic Layer>

The inorganic layer 16 is a thin film including an inorganic compound, and is provided on a surface of the underlying organic layer 14 or a surface of the support 12. In the gas barrier film 10, the inorganic layer 16 mainly exhibits gas barrier properties.

The surface of the support 12 includes a region such as unevenness or shadow of foreign matter to which the inorganic compound is not likely to adhere. By providing the underlying organic layer 14 and forming the inorganic layer 16 thereon, the region to which the inorganic compound is not likely to adhere is covered. Therefore, the inorganic layer 16 can be formed on the formation surface of the inorganic layer 16 without a gap.

A material of the inorganic layer 16 is not particularly limited, and various inorganic compounds that are used for a well-known gas barrier layer consisting of an inorganic compound exhibiting gas barrier properties can be used.

Examples of a material of the inorganic layer 16 include inorganic compounds, for example, a metal oxide such as aluminum oxide, magnesium oxide, tantalum oxide, zirconium oxide, titanium oxide, or indium tin oxide (ITO); a metal nitride such as aluminum nitride; a metal carbide such as aluminum carbide; a silicon oxide such as silicon oxide, silicon oxynitride, silicon oxycarbide, or silicon oxynitride-carbide; a silicon nitride such as silicon nitride or silicon nitride-carbide; a silicon carbide such as silicon carbide; a hydride thereof; a mixture of two or more kinds thereof; and a hydrogen-containing material thereof. In addition, a mixture of two or more kinds of the examples can be used.

In particular, silicon nitride, silicon oxide, silicon oxynitride, aluminum oxide, or a mixture of two or more kinds thereof is preferably used from the viewpoints that transparency is high and excellent gas barrier properties can be exhibited. In particular, a compound including silicon is preferably used, and silicon nitride is more preferably used from the viewpoint that excellent gas barrier properties can be exhibited.

The thickness of the inorganic layer 16 is not particularly limited and can be appropriately set depending on materials such that desired gas barrier properties can be exhibited.

The thickness of the inorganic layer 16 is preferably 10 to 150 nm, more preferably 12 to 100 nm, and still more preferably 15 to 75 nm.

It is preferable that the thickness of the inorganic layer 16 is 10 nm or more from the viewpoint that the inorganic layer 16 stably exhibiting sufficient gas barrier performance can be formed. In addition, in a case where the inorganic layer 16 is generally brittle and is excessively thick, breakage, cracking, peeling, or the like may occur. However, by adjusting the thickness of the inorganic layer 16 to be 150 nm or less, the occurrence of breakage can be suppressed.

In a case where a plurality of inorganic layers 16 are provided, the thicknesses of the inorganic layers 16 may be the same as or different from each other.

In addition, in a case where a plurality of inorganic layers 16 are provided, the materials of the inorganic layers 16 may be the same as or different from each other.

The inorganic layer 16 can be formed with a well-known method depending on materials.

For example, plasma CVD such as capacitively coupled plasma (CCP)-chemical vapor deposition (CVD) or inductively coupled plasma (ICP)-CVD, atomic layer deposition (ALD), sputtering such as magnetron sputtering or reactive sputtering, or various vapor deposition methods such as vacuum deposition can be suitably used.

In addition, the inorganic layer 16 may be formed through roll-to-roll, or may be formed with a sheet-feeding method using a support in the form of a cut sheet.

### <Protective Organic Layer>

The protective organic layer 18 is a layer for protecting the inorganic layer 16, the layer consisting of an organic material. By providing the protective organic layer 18, breakage or the like of the inorganic layer 16 can be prevented.

A material for forming the protective organic layer 18 is not particularly limited, and various well-known organic compounds can be used as in the underlying organic layer 14.

In addition, as the material for forming the protective organic layer 18, a urethane skeleton acrylate polymer such as a polymerizable composition for forming a second organic layer described in paragraphs “0016” to “0027” of JP2015-171798A may be used. In addition, the composition for forming the protective organic layer 18 may include an additive such as a monomer, an oligomer, or a polymer, a polymerization initiator, and a silane coupling agent, in addition to the urethane skeleton acrylate polymer.

As the protective organic layer 18, a resin film may be used. In this case, a pressure-sensitive adhesive layer may be provided between the resin film as the protective organic layer and the inorganic layer.

Regarding the resin film as the protective organic layer and the pressure-sensitive adhesive layer, a resin layer (resin film) and a bonding layer described in WO2018/211850A and WO2019/049634A can be used.

The thickness of the protective organic layer 18 may be appropriately set depending on the material for forming the protective organic layer 18, the material for forming the inorganic layer 16, the thickness of the inorganic layer 16, and the like. According to an investigation by the present inventors, the thickness of the protective organic layer 18 is preferably 0.1 to 50 μm, more preferably 0.5 to 25 μm, and still more preferably 1 to 10 μm. By adjusting the thickness of the protective organic layer 18 to be 0.1 μm or more, the inorganic layer 16 can be appropriately protected. In addition, by adjusting the thickness of the protective organic layer 18 to be 50 μm or less, the thickness of the gas barrier film 10 can be reduced.

Here, in a case where a gas barrier film including plural sets of combinations of the underlying organic layers 14 and the inorganic layers 16 is prepared, the formation of the underlying organic layer 14 and the formation of the inorganic layer 16 may be repeated according to the number of the combinations of the underlying organic layers 14 and the inorganic layers 16. In this case, in a case where the underlying organic layer 14 is formed on the inorganic layer 16, it is preferable that, in a state where a protective film is laminated to protect the inorganic layer 16 after forming the inorganic layer 16, the laminate is transported to a device for forming the underlying organic layer 14 and the protective film is peeled off immediately before forming the underlying organic layer 14.

In addition, it is preferable that the gas barrier film used for the packaging material with a gas barrier film according to the embodiment of the present invention has high gas barrier performance. Specifically, a water vapor transmission rate of the gas barrier film under conditions of a temperature of 25° C. and a relative humidity of 50% RH is preferably 1.0×10⁻³ g/(m²·day) or less, more preferably 4×10⁻⁴ g/(m²·day) or less, and still more preferably 1×10⁻⁴ g/(m²·day) or less.

### [Second Barrier Film]

FIG. 3 conceptually shows an example of a laminate including the second barrier film.

The second barrier film 50 shown in FIG. 3 includes a support 52 and an aluminum layer 54 in this order. In addition, the thermal fusion layer 62 is bonded to the aluminum layer 54 side of the second barrier film 50 through the adhesive layer 60.

As the support 52, a well-known sheet-shaped material (a film or a plate-shaped material) that is used as a support for various gas barrier films, various laminated functional films, and the like can be used.

As a material of the support 52, a support consisting of the same resin material as that of the support 12 of the above-described first gas barrier film can be used.

### <Aluminum Layer>

In the second barrier film 50, the aluminum layer 54 consisting of aluminum is formed on one surface of the support 52. In the second barrier film 50, the aluminum layer 54 mainly exhibits gas barrier properties.

The thickness of the aluminum layer 54 is not particularly limited and can be appropriately set depending on materials such that desired gas barrier properties can be exhibited.

The thickness of the aluminum layer 54 is preferably 0.5 to 50 μm, more preferably 3 to 40 μm, and still more preferably 5 to 30 μm.

The thickness of the aluminum layer 54 is preferably 0.5 μm or more from the viewpoint that the aluminum layer 54 that stably exhibits sufficient gas barrier performance can be formed. In addition, by adjusting the thickness of the aluminum layer 54 to be 50 μm or less, sufficient flexibility can be ensured.

The aluminum layer 54 may be directly formed on the support 52 by vapor deposition or the like, or may be formed by bonding aluminum foil to the support 52.

### <Thermal Fusion Layer>

The thermal fusion layer 22 is a layer for bonding the gas barrier film (first barrier film) 10 to an object by heat sealing (thermal welding). The thermal fusion layer 62 is a layer for bonding the second barrier film 50 to an object by heat sealing. The thermal fusion layer 22 and the thermal fusion layer 62 basically have the same configuration but may consist of different materials or may have different thicknesses. In the following description, in a case where the first barrier film and the second barrier film do not need to be distinguished from each other, the first barrier film and the second barrier film will be simply referred to as the barrier film.

Basically, the thermal fusion layer is formed of the same forming material as the object to which the barrier film is heat-sealed. For example, in a case where the object is an infusion bag, the thermal fusion layer is formed of the same material as the material for forming the infusion bag. That is, in a case where the object to be heat-sealed is formed of polyethylene (PE), a sheet-shaped material (film-shaped material) formed of PE may be used as the thermal fusion layer, and in a case where the object to be heat-sealed is formed of polypropylene (PP), a sheet-shaped material (film-shaped material) formed of PP may be used as the thermal fusion layer 22.

Specifically, as the material for forming the thermal fusion layer 22, a resin film described in paragraph “0015” of JP2012-075716A can be used.

In addition, the thickness of the thermal fusion layer is not also limited, and may be appropriately selected depending on the material for forming the thermal fusion layer and the shape, state, or the like of the object such as an infusion bag to be heat-sealed such that the object can be reliably thermally welded. Here, according to the study by the inventors of the present invention, the thickness of the thermal fusion layer is preferably 5 to 150 μm, more preferably 10 to 100 μm, and still more preferably 30 to 70 μm. The thickness of the thermal fusion layer is preferably 5 μm or more from the viewpoints that, for example, more reliable heat sealing can be performed and unevenness of a surface of the object to be heat-sealed can be suitably absorbed. The thickness of the thermal fusion layer is preferably 150 μm or less from the viewpoints that, for example, the thickness of the gas barrier film can be reduced and permeation of water vapor or oxygen from a side surface of the thermal fusion layer during thermal welding of the infusion bag or the like can be more effectively suppressed.

### <Adhesive Layer>

The adhesive layer 20 is a layer for bonding the thermal fusion layer 22 and the surface of the gas barrier film 10 on the protective organic layer 18 side. In addition, the adhesive layer 60 is a layer for bonding the thermal fusion layer 62 and the surface of the second barrier film 50 on the aluminum layer 54 side.

As the adhesive layer 20, all of well-known adhesives through which the thermal fusion layer 22 can adhere to the protective organic layer 18 can be used. Likewise, as the adhesive layer 60, all of well-known adhesives with which the thermal fusion layer 62 can adhere to the aluminum layer 54 can be used.

In addition, the thickness of the adhesive layer 20 is not limited, and may be appropriately selected such that the thermal fusion layer 22 can reliably adhere to the protective organic layer 18. In addition, the thickness of the adhesive layer 60 is not limited, and may be appropriately selected such that the thermal fusion layer 62 can reliably adhere to the aluminum layer 54.

Here, the packaging material 100 with a gas barrier film according to the embodiment of the present invention includes a haze layer having a haze of 10% to 50% between the packaging material 102 and the first barrier film 10. In the example shown in FIG. 1, the thermal fusion layer 22 is the haze layer. That is, the layer in contact with the space 104 formed between the packaging material 102 and the first barrier film 10 is the haze layer having a haze of 10% to 50%.

As described above, in a case where the transparent gas barrier film including the organic layer and the inorganic layer is thermally fused to the packaging material (bag body) through the thermal fusion layer, during the thermal fusion of the entire surface, the inorganic layer is fractured, and there is a concern that barrier properties may decrease. In addition, in a case where a region to be thermally fused is large, wrinkles are generated due to the effect of stress generated during contraction by heat, and there is a risk that air bubbles are formed in an adhesive layer. Therefore, the thermal fusion between the gas barrier film and the packaging material is performed only in peripheral portions. Accordingly, as shown in FIG. 1, the space 104 is formed between the packaging material 102 and the thermal fusion layer 22.

In addition, in a configuration where the gas barrier film having transparency is bonded to one surface of the packaging material and the second barrier film including the aluminum layer not having transparency is bonded to the other surface of the packaging material, the inside of the packaging material is checked using reflected light of light incident from the transparent gas barrier film side into the bag body. In this case, in the configuration including the space between the bag body and the thermal fusion layer, light is reflected from an interface between the space and the bag body. Therefore, it was found that there is a problem in that reflected glare of strong light of a light source or the like occurs such that the visibility of the inside of the packaging material deteriorates.

On the other hand, the packaging material 100 with a gas barrier film according to the embodiment of the present invention includes the thermal fusion layer 22 that is the haze layer having a haze of 10% to 50% between the packaging material 102 and the gas barrier film 10. As a result, light incident from the gas barrier film 10 side is diffused in the haze layer. Therefore, strong light having high directivity of a light source or the like is diffused, and then is reflected from an interface between the space and the bag body. Therefore, reflected glare of the strong light having high directivity of the light source or the like can be reduced. As a result, the visibility of the inside of the packaging material 102 can be improved.

Here, by improving the haze of the haze layer to be 10% or more, strong light having high directivity of a light source or the like can be diffused, and the visibility of the inside of the packaging material can be improved. From this viewpoint, the haze of the haze layer is preferably 10% or more and more preferably 15% or more. On the other hand, in a case where the haze of the haze layer is excessively high, the transparency deteriorates, and there is a concern that the visibility of the inside of the packaging material may decrease. Accordingly, by improving the haze of the haze layer to be 50% or less, transparency is ensured, and the visibility of the inside of the packaging material can be improved. From this viewpoint, the haze of the haze layer is preferably 50% or less and more preferably 40% or less.

The haze value can be measured according to JIS K 7136 (2000) using a commercially available haze meter SH-7000 (manufactured by Nippon Denshoku Industries Co., Ltd.).

In addition, in the example shown in FIG. 1, the thermal fusion layer 22 is the haze layer. As described above, the thermal fusion layer 22 is a resin film of PE, PP, or the like. By adjusting the haze of the resin film to be 10% to 50%, a roughening treatment such as blasting or embossing may be performed on the thermal fusion layer 22.

In addition, in the example shown in FIG. 1, the thermal fusion layer 22 is the haze layer, but the present invention is not limited thereto. A haze layer different from the thermal fusion layer may be provided. In this case, the haze layer may be bonded to a region corresponding to the space in the surface of the thermal fusion layer on the packaging material side.

In addition, in the packaging material with a gas barrier film according to the embodiment of the present invention, in order to ensure the visibility of the inside of the packaging material 102, the haze value of the first barrier film (gas barrier film) 10 is preferably is less than the haze value of the haze layer.

In addition, in the packaging material with a gas barrier film according to the embodiment of the present invention, in order to ensure the visibility of the inside of the packaging material 102, a total light transmittance of the gas barrier film 10 at a wavelength of 380 nm to 780 nm is preferably 85% or more, more preferably 87% or more, and still more preferably 90% or more.

Hereinbefore, the packaging material with a gas barrier film according to the embodiment of the present invention has been described in detail. However, the present invention is not limited to the above-described aspects and various improvements and changes may be made within a range not departing from the scope of the present invention.

### EXAMPLES

Hereinafter, the present invention will be described in detail using Examples. The present invention is not limited to specific examples described below.

### [Preparation of Gas Barrier Film (First Barrier Film)]

### <Support>

A polyethylene terephthalate film (PET film, manufactured by Toyobo Co., Ltd., trade name: A4300, thickness: 100 μm, width: 1000 mm, length: 100 m) was prepared, and an underlying organic layer and an inorganic layer were formed on a single surface side of the PET film in the following procedure.

### <Formation of Underlying Organic Layer>

TMPTA (manufactured by Daicel-Allnex Ltd.) and a photopolymerization initiator (ESACURE KTO 46, manufactured by Lamberti S.p.A.) were prepared and were weighed such that a weight ratio thereof was 95:5. These components were dissolved in methyl ethyl ketone. As a result, a coating solution (composition for forming an organic layer) having a concentration of solid contents of 15% was obtained. This coating solution was applied to the above-described PET film through RtoR using a die coater, and the substrate was allowed to pass through a drying zone at 50° C. for 3 minutes. Next, while being heated using a backup roll at 80° C., the coating film was irradiated and cured with ultraviolet rays (cumulative irradiation amount: about 600 mJ/cm2), and the laminate was wound. Before contact with an initial film surface touch roll after the UV curing, a polyethylene protective film was bonded, and then the laminate was wound. The thickness of the underlying organic layer formed on the PET film was 2 μm.

### <Formation of Inorganic Layer>

Using a RtoR CVD device, an inorganic layer (silicon nitride film) was formed on a surface of the underlying organic layer.

Specifically, the wound PET film with the underlying organic layer was fed, the protective film was peeled after passing through a final film surface touch roll before film formation, and the inorganic film was formed on the exposed resin underlying organic layer. For the formation of the inorganic film, silane gas (flow rate: 160 sccm), ammonia gas (flow rate: 370 sccm), hydrogen gas (flow rate: 590 sccm), and nitrogen gas (flow rate: 240 sccm) were used as raw material gas. As a power supply, a silicon nitride film was formed using a high frequency power supply having a frequency of 13.56 MHZ. Before contact with an initial film surface touch roll after the formation of the inorganic layer, a polyethylene protective film was bonded, and then the laminate was wound. The film formation pressure was 40 Pa, and the peak film thickness was 30 nm.

### <Formation of Protective Organic Layer>

A protective organic layer was formed on the surface of the inorganic layer. As a coating liquid for forming the protective organic layer, a urethane skeleton acrylate polymer (ACRIT 8BR930, manufactured by Taisei Fine Chemical Co., Ltd.), an additive (VYLON U1510, manufactured by Toyobo Co., Ltd.), and a silane coupling agent (KBM5103, manufactured by Shin-Etsu Silicone Co., Ltd.) were mixed at a ratio of 73.25% to 15% to 10%, 1.75% of a photopolymerization initiator (ESCURE KTO46, manufactured by Lamberti S.p.A.) was added, and the components were dissolved in methyl ethyl ketone to prepare a coating liquid having a concentration of solid contents of 15%. This coating liquid was directly applied to the inorganic layer surface through roll-to-roll using a die coater, and was allowed to pass through a drying zone at 100° C. for 3 minutes. Next, while being wound around a heat roll heated to 60° C., the coating film was irradiated and cured with ultraviolet rays (cumulative irradiation amount: about 600 mJ/cm2), and the laminate was wound. The thickness of the protective organic layer formed on the inorganic layer was 1 μm. This way, a gas barrier film was prepared.

The prepared gas barrier film was cut into 100 mm×100 mm, and the water vapor transmission rate was measured using a MOCON method. For the measurement, AQUATRAN 2 (manufactured by Hitachi High-Tech Corporation) was used. The measurement was evaluated at a temperature of 40° C. and a humidity of 90%, and the obtained value was converted into a value at a temperature of 25° C. and a humidity of 50% RH by the Arrhenius plot to derive a water vapor transmission rate at a temperature of 25° C. and a humidity of 50% RH.

As a result of the measurement, the water vapor transmission rate of the gas barrier film was 1×10⁻⁴ g/(m²·day) or less.

### [Preparation of Second Barrier Film]

A polyurethane adhesive (main agent: polyester polyol; RU-77T manufactured by Rock Paint Co., Ltd., curing agent: aliphatic isocyanate; H-7, manufactured by Rock Paint Co., Ltd.) was applied to a PET film (thickness: 12 μm) as a support, and aluminum foil (thickness: 7 μm) was bonded to form an aluminum layer. As a result, a second barrier film was prepared.

### Example 1

As a thermal fusion layer, a resin film (polyethylene, manufactured by Sun A Kaken Co., Ltd., thickness: 50 μm) was prepared.

Blasting was performed on the resin film such that the haze value was 11.80%. The haze value was measured according to JIS K 7136 (2000) using r SH-7000 (manufactured by Nippon Denshoku Industries Co., Ltd.).

The resin film on which blasting was performed was bonded to the protective organic layer side of the gas barrier film using a polyurethane adhesive (main agent: polyester polyol; RU-77T manufactured by Rock Paint Co., Ltd., curing agent: aliphatic isocyanate; H-7, manufactured by Rock Paint Co., Ltd.) to obtain a laminate including the first barrier film. The thickness of the adhesive layer was 3 μm.

The resin film on which blasting was not performed was bonded to the aluminum layer side of the second barrier film using a polyurethane adhesive (main agent: polyester polyol; RU-77T manufactured by Rock Paint Co., Ltd., curing agent: aliphatic isocyanate; H-7, manufactured by Rock Paint Co., Ltd.) to obtain a laminate including the second barrier film.

As a packaging material, a polyethylene bag was prepared.

The other surface of the polyethylene bag and the thermal fusion layer side of the laminate including the second barrier film were fused only in peripheral portions using a heat sealing method.

Next, one surface of the polyethylene bag and the thermal fusion layer side of the laminate including the first barrier film were fused only in peripheral portions using a heat sealing method. By sealing only the peripheral portion, a space is formed between the polyethylene bag and the thermal fusion layer.

As a result, a packaging material with a gas barrier film was prepared.

### Examples 2 and 3 and Comparative Example 1

Packaging materials with a gas barrier film were prepared using the same method as that of Example 1 except that blasting to be performed on the thermal fusion layer (resin film) bonded to the first barrier film was changed such that the haze values of the thermal fusion layers were adjusted as shown in Table 1 below.

### Comparative Example 2

A packaging material with a gas barrier film was prepared using the same method as that of Example 1 except that a PET film (manufactured by Toyobo Co., Ltd., trade name: A4300, thickness: 50 μm) was used as the thermal fusion layer bonded to the first barrier film.

### [Evaluation]

4.5 g of white silicone resin fine particles having a particle size of 6 μm and 0.002 g of black powder were sealed in the packaging material, and evaluation was performed based on the following standards on a work table for performing visual inspection at an illuminance of 1000 (1×) for a visual inspection time of 1 minute. The evaluation was performed at three levels using powders having particle sizes of 50 μm, 80 μm, and 100 μm as the black powder.
AA: the visibility is excellent.
A: the inside is recognizable without any problem.
B: the visibility is poor, and it is difficult to recognize the inside.
C: the inside cannot be recognized at all.

The results are shown in Table 1.

TABLE 1

| | Thermal Fusion Layer | | | Evaluation: Visibility | | |
|---|---|---|---|---|---|---|
| | | | Thickness | Black Powder | | |
| | Material | Haze Value | (μm) | 50 μm | 80 μm | 100 μm |
| Example 1 | PE | 11.80% | 50 | AA | AA | AA |
| Example 2 | PE | 28.67% | 50 | A | AA | AA |
| Example 3 | PE | 45.78% | 50 | A | A | AA |
| Comparative | PE | 68.90% | 50 | C | C | C |
| Example 1 | | | | | | |
| Comparative | PET | 0.78% | 50 | C | C | B |
| Example 2 | | | | | | |

It can be seen from Table 1 that, in the packaging material with a gas barrier film according to the embodiment of the present invention, the visibility of the inside of the packaging material is excellent. On the other hand, in Comparative Example 1, the haze value of the thermal fusion layer was excessively high. Therefore, the transparency decreased, and the visibility was poor. In addition, in Comparative Example 2, the haze layer was not provided. Therefore, the visibility of the inside deteriorated due to reflected glare of a light source.

In addition, it can be seen from a comparison between Examples 1 to 3 that the haze value of the haze layer is preferably 10% to 50%.

From the above results, the effects of the present invention are obvious.

### EXPLANATION OF REFERENCES

10: first barrier film (gas barrier film)
12, 52: support
14: underlying organic layer
16: inorganic layer
18: protective organic layer
20, 60: adhesive layer
22, 62: thermal fusion layer
50: second barrier film
54: aluminum layer
100: packaging material with gas barrier film
102: packaging material
104, 106: space

What is claimed is:

1. A packaging material with a gas barrier film, comprising:
a packaging material that includes a resin film;
a first barrier film that is bonded to one surface of the packaging material; and
a second barrier film that is bonded to a surface of the packaging material opposite to the one surface and includes an aluminum layer,
wherein the first barrier film includes an underlying organic layer, an inorganic layer, and a protective organic layer in this order on a support,
peripheral portions of the packaging material and the first barrier film are bonded to form a space between the packaging material and the first barrier film, and
a haze layer having a haze of 10% to 50% is provided between the packaging material and the first barrier film.

2. The packaging material with a gas barrier film according to claim 1,
wherein a thermal fusion layer that bonds the packaging material and the first barrier film to each other is provided, and
the thermal fusion layer is the haze layer.

3. The packaging material with a gas barrier film according to claim 2,
wherein a surface of the first barrier film on the protective organic layer side and the thermal fusion layer adhere to each other through an adhesive layer.

4. The packaging material with a gas barrier film according to claim 1,
wherein a water vapor transmission rate of the first barrier film under conditions of a temperature of 25° C. and a relative humidity of 50% RH is 1.0×10⁻⁴ g/(m²·day) or less.

5. The packaging material with a gas barrier film according to claim 1,
wherein a haze value of the first barrier film is less than a haze value of the haze layer.

6. The packaging material with a gas barrier film according to claim 1,
wherein a total light transmittance of the first barrier film at a wavelength of 380 nm to 780 nm is 85% or more.

7. The packaging material with a gas barrier film according to claim 2,
wherein a water vapor transmission rate of the first barrier film under conditions of a temperature of 25° C. and a relative humidity of 50% RH is 1.0×10⁻⁴ g/(m²·day) or less.

8. The packaging material with a gas barrier film according to claim 2,
wherein a haze value of the first barrier film is less than a haze value of the haze layer.

9. The packaging material with a gas barrier film according to claim 2,
wherein a total light transmittance of the first barrier film at a wavelength of 380 nm to 780 nm is 85% or more.

10. The packaging material with a gas barrier film according to claim 3,
wherein a water vapor transmission rate of the first barrier film under conditions of a temperature of 25° C. and a relative humidity of 50% RH is 1.0×10⁻⁴ g/(m²·day) or less.

11. The packaging material with a gas barrier film according to claim 3,
wherein a haze value of the first barrier film is less than a haze value of the haze layer.

12. The packaging material with a gas barrier film according to claim 3,
wherein a total light transmittance of the first barrier film at a wavelength of 380 nm to 780 nm is 85% or more.

13. The packaging material with a gas barrier film according to claim 4,
wherein a haze value of the first barrier film is less than a haze value of the haze layer.

14. The packaging material with a gas barrier film according to claim 4,
wherein a total light transmittance of the first barrier film at a wavelength of 380 nm to 780 nm is 85% or more.

15. The packaging material with a gas barrier film according to claim 5,
wherein a total light transmittance of the first barrier film at a wavelength of 380 nm to 780 nm is 85% or more.
